(19) United States
(12) Patent Application Publication
(10) Pub. No.: US 2013/0125160 A1
(43) Pub. Date: May 16, 2013

(54) INTERACTIVE TELEVISION PROMOTIONS

(71) Applicants: Antonio Fontan, San Jose, CA (US); Sascha Prueter, San Francisco, CA (US); Tim Herby, Los Altos, CA (US); Chris Welden, Mountain View, CA (US)

(72) Inventors: Antonio Fontan, San Jose, CA (US); Sascha Prueter, San Francisco, CA (US); Tim Herby, Los Altos, CA (US); Chris Welden, Mountain View, CA (US)

(73) Assignee: MICROSOFT CORPORATION, Redmond, WA (US)

(21) Appl. No.: 13/298,199

(22) Filed: Nov. 16, 2011

(51) Int. Cl. H04N 21/482; H04N 7/16

(52) U.S. Cl. 725/23; 725/39

(57) ABSTRACT

Embodiments for executing interactive television promotions are disclosed. One example embodiment includes an entertainment system comprising a sensor input to receive from one or more sensors observation information indicating a natural user interface behavior of a viewer, a program input to receive from a broadcaster a video program, an output configured to output to a display the video program, and a module input to receive from an interaction authority an experience module associated with the video program, the experience module configured to execute an experience instruction if the natural user interface behavior of the viewer satisfies a condition defined by the experience module.

### BACKGROUND

Television programs often include promotions for in-studio audience members present in the studio during filming or for call-in viewers that use a telephone to call in to the television broadcasters during filming. Only a select few people are usually present in-studio during filming and/or allowed to participate in a promotion via the telephone. Furthermore, it can be difficult to fully incorporate an out-of-studio call-in viewer to the television program in a way that is enjoyable for all other viewers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore the claimed subject matter is not limited to implementations that, solve any or all disadvantages noted in any part of this disclosure.

Embodiments of an entertainment system are provided. In one example embodiment, an entertainment system comprises a sensor input to receive from one or more sensors observation information indicating a natural user interface behavior of a viewer, a program input to receive from a broadcaster a video program, an output configured to output to a display the video program, and a module input to receive from an interaction authority an experience module associated with the video program, the experience module configured to execute an experience instruction if the natural user interface behavior of the viewer satisfies a condition defined by the experience module.

### BRIEF DESCRIPTION OF THE DRAWINGS

FIG. 1 shows a non-limiting example of a promotion environment.

FIG. 2 is a flow chart illustrating a method for enabling promotions according to an embodiment of the disclosure.

FIG. 3 is a flow chart illustrating a method for displaying an avatar according to an embodiment of the disclosure.

FIG. 4 shows an example processing pipeline of a sensor analysis system.

FIG. 5 schematically shows an example promotion system according to an embodiment of the present disclosure.

FIG. 6 schematically shows a non-limiting entertainment system.

### DETAILED DESCRIPTION

Granting awards to viewers of video content via televised promotions provides incentives for viewers to watch the video content, increasing viewership of the content and possibly increasing advertising revenue generated by the content. However, the number of viewers eligible for participation in a live promotion tends to be limited to the viewers present in the studio during filming of the content, or to a very limited number of viewers at home reached by telephone. By using a sensor present in the home of the viewer, such as a color video camera, a depth camera, and/or a microphone, and transmitting video, audio, and/or a computer-modeled avatar of the viewer to be used in a live broadcast of the video content, the number of home viewers eligible to participate in the promotion may be increased, and may provide effective and engaging interactive television content.

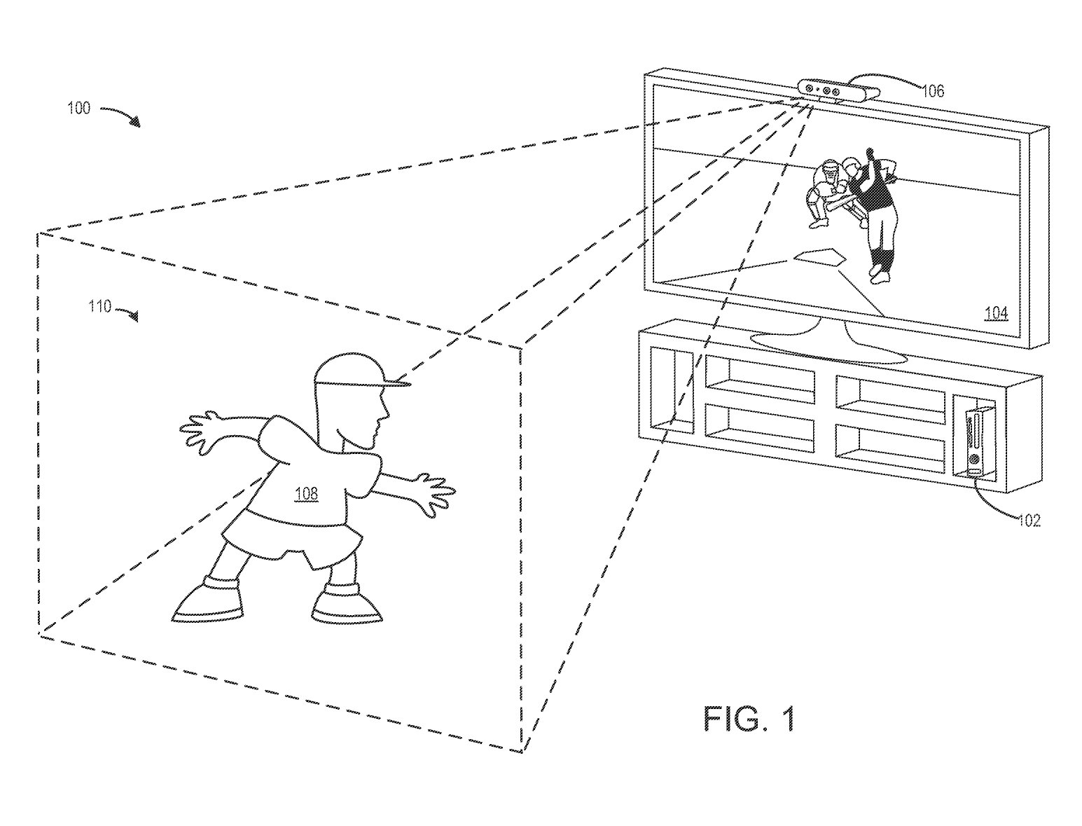

FIG. 1 shows a non-limiting example of a promotion environment 100 in the form of an entertainment system 102, a display device 104, and one or more sensors 106. The display device 104 may be operatively connected to the entertainment system 102 via a display output of the entertainment system. For example, the entertainment system may include an HDMI or other suitable display output. The display device 104 as shown in FIG. 1 is in the form of a television or a computer monitor, which may be used to present linear video content and/or promotion content to a viewer 108.

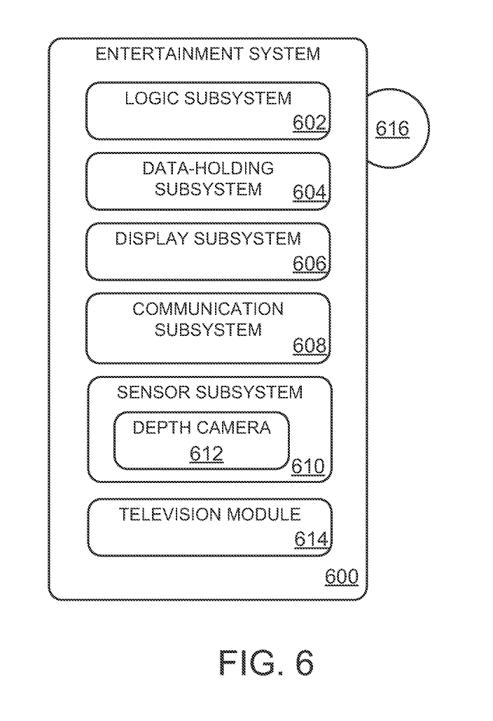

As used herein, linear video content refers to video content that progresses without navigational control from a viewer, and may include television programming, movies, etc. Linear video content may be presented in a live broadcast (e.g. in real time), or may be time shifted for playback after broadcasting. The entertainment system 102 may receive linear video content via a satellite feed, cable feed, over-the-air broadcast, via a network (e.g., the Internet), or via any other suitable video delivery mechanism. More detailed information regarding the entertainment system will be presented with respect to FIG. 6.

In addition to presenting linear video content, the promotion environment 100 may facilitate viewer participation in a promotion that is associated with the linear video content. A promotion may be developed by any number of different entities, including but not limited to the creators, advertisers, producers, etc. of the linear video content. The promotion may include one or more predefined conditions set by a creator of the promotion.

Any actions performable by the viewer 108 and detectable by one or more sensors 106 may serve as predefined conditions within the scope of this disclosure. Such actions taken by the viewer 108 and sensed by the sensor 106 while carrying out a promotion may be referred to as a natural user interface behavior of the viewer. The natural user interface behavior may include actions that can be performed by the viewer 108. Example actions include movements made by the viewer 108 that may be detected by a camera audio actions made by the viewer 108 that may be detected by a microphone, etc. Additionally or alternatively, the actions may include the viewer 108 displaying objects that can be recognized by the entertainment system 102. For example, the viewer 108 may display a product that is imaged by a camera, and the entertainment system 102 may identify the product by comparing the image of the product to other known images or by scanning a barcode of the product.

During a promotion, the entertainment system 102 may output an experience instruction based on the natural user interface behavior of the viewer. In one example, the experience instruction may include sending an interpretation of the natural user interface behavior of the viewer to an entity associated with the promotion, such as a creator of the promotion. The interpretation may include information regarding the natural user interface behavior of the viewer that can be used by the entity associated with the promotion to determine if the behavior of the viewer meets a condition defined by a promotion. For example, the promotion may include recognizing that the viewer has performed the actions specified in the promotion, and rewarding the viewer for performing the actions. In some embodiments, interpreting the natural user interface behavior of the viewer may include the entertainment system 102 itself identifying the actions the viewer has performed, and making a decision as to whether the actions satisfy the conditions of the promotion.

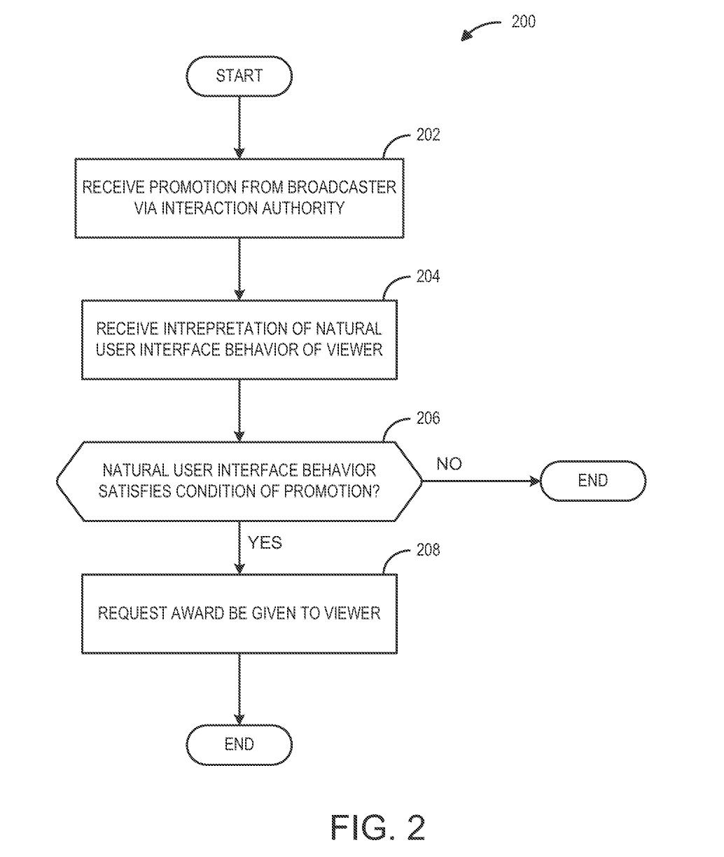

The decision as to whether the natural user interface behavior of the viewer satisfies a condition of the promotion may be used to grant an award to the viewer. In this case, the experience instruction output by the entertainment system 102 may include requesting an award be granted to the viewer from an entity associated with the promotion, such as the creator or a broadcaster. In other embodiments, the experience instruction may include the entertainment system 102 unlocking a previously downloaded and blocked award. More information regarding rewarding the viewer will be presented below with respect to FIG. 2.

The interpretation may also include creating a virtual representation of the viewer 108, such as an avatar. The virtual representation may mimic the actions the viewer 108 performs during the promotion. This representation may be sent to an outside entity, such as a broadcaster, for use during the promotion. For example, an avatar of the viewer may be integrated into a video program so that the viewer is viewable by others as part of the video program. When the avatar is integrated into a video program, it may be integrated in an otherwise unaltered broadcast of the video program. In other embodiments, the avatar may be integrated with an augmented reality broadcast of the video program that is altered in addition to the integration of the avatar. For example, the avatar could be interacting with virtual objects within the video program.

One example promotion may include a promotion created by an advertiser to accompany a piece of advertising content broadcast within a video program. The promotion may include the viewer 108 displaying to the sensor 106 the product that is being advertised. The entertainment system 102 may determine if the viewer 108 is displaying the product. If so, the viewer 108 may be granted an award, such as coupons for the product advertised.

In another example, the promotion may include the viewer 108 performing an action in front of a live television audience. For example, the viewer 108 may be watching a live broadcast of a baseball game. The promotion may include the viewer 108 acting out the motions of catching a baseball that is hit by a baseball player playing in the game. The entertainment system 102 may send an avatar of the viewer 108 catching the baseball to the broadcaster of the baseball game. The broadcaster may then include the avatar of the viewer 108 catching the ball in a live broadcast of the baseball game, and if the viewer 108 “catches” the ball, the viewer 108 may be awarded a prize, such as a new car.

FIG. 1 shows the promotion environment 100 that may be used by the viewer 108 in order to participate in a promotion. As explained above, the actions performed by the viewer 108 during a promotion may be observed by one or more sensors 106, such a microphone or depth camera, that identifies, monitors, or tracks the viewer 108 in an observed scene 110. In particular, each sensor 106 may be operable to generate an information stream of recognition information that is representative of the observed scene 110, and the information streams may be interpreted and modeled to identify the viewer 108. The one or more sensors 106 may be operatively connected to the entertainment system 102 via one or more sensor inputs. As a non-limiting example, the entertainment system 102 may include a universal serial bus to which a depth camera may be connected.

The entertainment system 102 may be configured to communicate with one or more remote computing devices, not shown in FIG. 1, in order to execute a promotion. As explained above, the entertainment system 102 may receive linear video content directly from a broadcaster, or may receive linear video content through a third party, such as a digital media delivery service. The information to carry out the promotion may be contained within the video content received from the broadcaster or digital media delivery service. In some embodiments, additional information to carry out the promotion may be received from other devices in communication with the entertainment system 102 such as devices used by creators of the promotions. For example, these devices may include an interaction authority that directs the execution of the promotions.

While the embodiment depicted in FIG. 1 shows the entertainment system 102, display device 104, and sensor 106 as separate elements, in some embodiments one or more of the elements may be integrated into a common device. For example, the entertainment system 102, display device 104, and sensor 106 may be integrated in a laptop computer, tablet computer, mobile telephone, mobile computing device, etc.

FIG. 2 depicts a method 200 for enabling a promotion. Method 200 may be executed by a device in communication with the entertainment system 102, such as a digital media delivery service. As explained above, the digital media delivery service may receive digital media content from outside sources, such as the creators of the media content, and send them to one or more subscribing client devices, such as the entertainment system 102. Additionally or alternatively, the digital media service may be configured to store account information for one or more users of the entertainment system 102. The account information may include information regarding a digital representation of a user of the entertainment system 102, such as an avatar. Additionally, account information may include promotion awards and achievements accrued by the user of the entertainment system 102, as will be described in more detail herein.

Method 200 comprises, at 202, receiving a promotion from a broadcaster of a video program via an interaction authority. As explained above, the interaction authority is configured to direct the execution of promotions. The interaction authority may utilize a user interface that a creator of a promotion, e.g. the broadcaster, may utilize to detail the conditions of the promotion. The interaction authority may store a list of promotions associated with linear video content (e.g. a video program), including the conditions of each promotion, and may send information regarding a selected promotion to the digital media delivery service. In some embodiments, a broadcaster or the digital media service may serve as the interaction authority.

The digital media service may then include the promotion in band with the video content it sends to an entertainment system of a viewer. However, in some embodiments, the promotion may be sent as metadata that is out of band from the video content, e.g., as metadata that is associated with the video content but that is sent separately from the video content via a metadata service. In other embodiments, the entertainment system may contact one or more sources external from both the digital media delivery service and the metadata service, to determine if any relevant promotions are available, and if so, receive the promotion from the external source. Any mechanism of sending the promotion to the entertainment system is within the scope of this disclosure.

The conditions of the received promotion may detail a natural user interface behavior performable by a viewer, which as explained above with respect to FIG. 1, may include an action detectable by a sensor. Upon receiving the promotion with the video content, the entertainment system may display the promotion, and/or information relating to the promotion, to a viewer, and create an interpretation of the natural user interface behavior of the viewer to send to the digital media delivery service and/or another entity.

A promotion may be configured to trigger responsive to a particular event. In some embodiments, the promotion may be configured to start immediately following its reception at the entertainment system. In other embodiments, the promotion may include information indicating a particular start time within the video content it is associated with. For example, the promotion may include a timestamp indicating the time within the video content that the promotion may start. Further, in some embodiments, the promotion may be valid for the entire duration of the video content, while in other embodiments, the promotion may be valid for only a portion of the video content

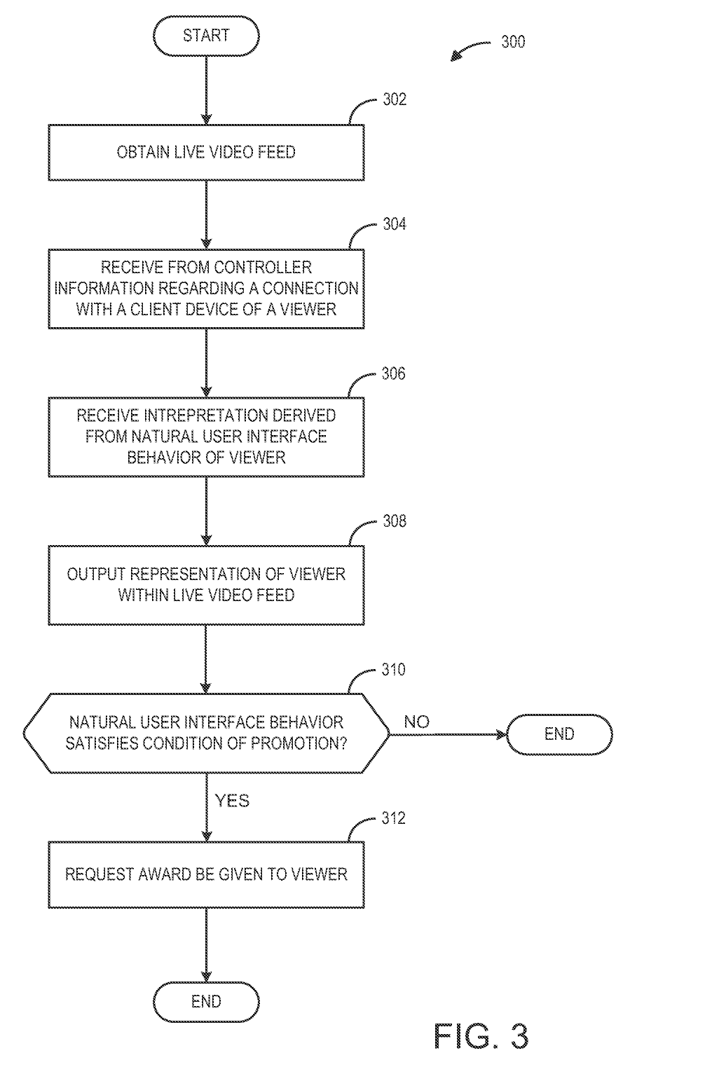

Thus, at 204, method 200 comprises receiving an interpretation of the natural user interface behavior of the viewer performed while viewing the video program. As explained above with respect to FIG. 1, the interpretation may include a decision about whether the natural user interface behavior of the viewer satisfies a condition of the promotion, or it may include the natural user interface behavior of the viewer in its raw, unanalyzed form. In one example, the interpretation may be usable by a broadcaster to display an avatar of the viewer in a video program, which be explained in more detail below with respect to FIG. 3.

At 206, method 200 comprises determining if the natural user interface behavior of the viewer satisfies a condition of the promotion. The conditions of the promotion may include an action that is to be performed by a viewer, such as presenting a particular product to the sensors. If the action performed by the viewer as determined by the interpretation of the natural user interface behavior does not meet the condition defined in the promotion, for example, if the viewer is not performing the defined action, method 200 ends. However, if the natural user interface behavior of the viewer does satisfy a condition of the promotion, method 200 proceeds to 208 to request that an award be given to the viewer.

Awards granted to qualifying viewers may be defined by the creator of the promotion and included in the predetermined conditions of the promotion. In some embodiments, the digital media delivery service may be configured to notify a creator of the promotion that the viewer is to be granted an award. In turn, the creator of the promotion may grant the viewer a physical award, such as money, coupons, products, etc. Awards may also include non-physical or virtual awards, such as awards for the viewer's avatar (e.g., a new outfit) or an indication of an achievement; made by the viewer stored in the account information for that viewer in the digital media delivery service.

The digital media delivery service itself may be configured to grant the award to the viewer, particularly if the award defined in the promotion is a virtual award. For example, when the digital media delivery service receives information regarding a promotion, the information may include an award that is downloaded to the service. Upon determining that the viewer is to receive an award, the previously downloaded award may be unlocked and awarded to the viewer. In some embodiments, an outside entity, such as the broadcaster, content creator, etc. may ultimately grant the award. In such cases, the digital media delivery service may be configured to notify the broadcaster or content creator that the natural user interface behavior of the viewer satisfies the condition of the promotion. Upon requesting an award be given, method 200 ends.

FIG. 3 shows a flow chart illustrating a method 300 for displaying an avatar of a viewer in a live video broadcast. Method 300 may be performed on one or more computing device of a broadcaster of the live video broadcast. Method 300 comprises, at 302, obtaining a live video feed. The live video feed may be any video of an event that; is captured in real time for immediate broadcast. The live video feed may be sent from a camera to a device of the broadcaster, and then broadcast to one or more entertainment systems for viewing.

At 304, method 300 comprises receiving from a controller information regarding a connection with an entertainment system of a viewer. In some promotions, only a subset of viewers from all viewers eligible for the promotion may be selected to participate. For example, in the baseball promotion explained above with respect to FIG. 1, all viewers watching the baseball game may be eligible for the promotion, but only one viewer may be selected to have his or her avatar displayed in the live broadcast. In this embodiment, a controller may enable an outside entity, such as a promotion creator, to select the winner during execution of the promotion. The controller may then send the winner's information to the broadcaster so that the winning viewer's device (e.g. the winner's entertainment system) and the broadcaster's device may be connected.

At 306, method 300 comprises receiving an interpretation derived from a natural user interface behavior of the viewer as observed by a sensor. As explained above, this natural user interface behavior of the viewer includes an action detectable by a sensor, such as a depth camera and/or microphone. In this embodiment, the interpretation of the natural user interface behavior of the viewer includes an avatar of the viewer performing a representation of the actions the viewer is actually performing.

Method 300 comprises, at 308, outputting a representation of the viewer within the live video feed. The representation may include an avatar of the viewer derived from the sensor information. The avatar may include a digital representation of the viewer received at the broadcaster's device from the viewer's device. In other embodiments, the representation may include an unaltered video stream of the viewer as derived from the sensor. In either case, the digital representation may be output from the broadcaster's device as part of the video broadcast that is sent to additional viewers. For example, the representation may be included in the live video feed that is broadcast to one or more additional viewers in an over-the-airways broadcast, in a satellite broadcast, etc. Any method of including the representation in the live video feed received by the broadcaster and sent to additional viewers is within the scope of this disclosure. Such methods include, but are not limited to using a raw video feed from the client device, or using a local device that interprets the data, and outputs the avatar interpretation to the broadcaster (e.g., via HDMI).

At 310, method 300 optionally comprises determining if the natural user interface behavior of the viewer satisfies a condition of the promotion. The broadcaster's device itself may be configured to make this determination. However, in some embodiments, the determination may be made by a creator of the promotion, and a notification of the determination may be sent to the device. If the natural user interface behavior of the viewer does not satisfy a condition of the promotion, method 300 ends. If it does satisfy a condition of the promotion, method 300 proceeds to 312 to request an award be given to the viewer. Requesting an award be given to the viewer may include notifying an award-granting device, such as a digital media delivery service, or may include notifying the creator of the promotion, such as the broadcaster. Upon requesting an award be given, method 300 ends.

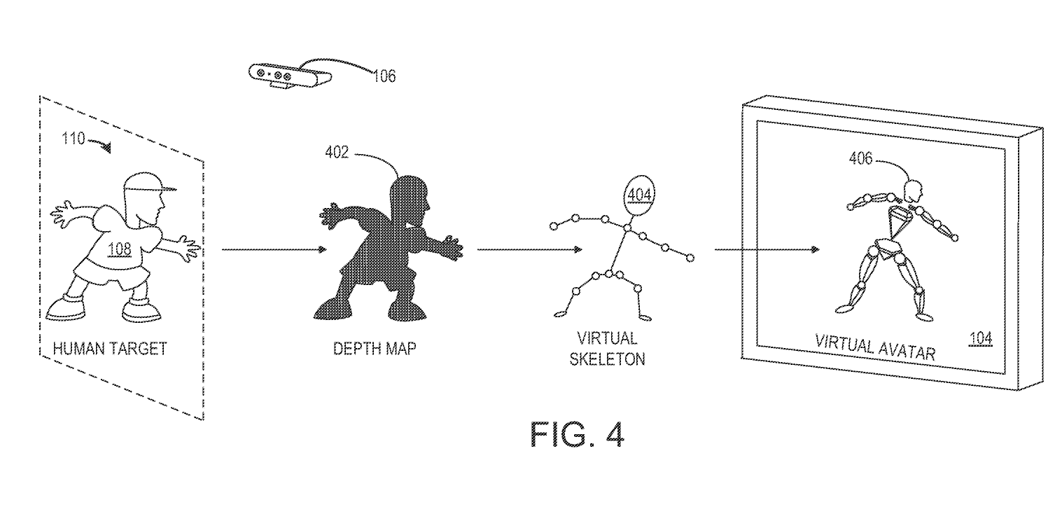

In the embodiments described above with respect to FIGS. 2 and 3, granting an award to a viewer relies on determining if one or more conditions of a promotion are satisfied. FIG. 4 shows an example environment of one embodiment of a system for determining if a condition of a promotion has been met. Specifically, FIG. 4 shows a simplified processing pipeline in which a human target, such as the viewer 108, is modeled as a virtual skeleton 404. It will be appreciated that a processing pipeline may include additional steps and/or alternative steps than those depicted in FIG. 4 without departing from the scope of this disclosure.

As shown in FIG. 4, the three-dimensional appearance of the viewer 108 and the rest of observed scene 110 may be imaged by a depth camera (e.g., sensors 106 of FIG. 1). The depth camera may determine, for each pixel, the three dimensional depth of a surface in the observed scene 110 relative to the depth camera. Virtually any depth finding technology may be used without departing from the scope of this disclosure.

The three dimensional depth information determined for each pixel may be used to generate a depth map 402. Such a depth map may take the form of virtually any suitable data structure, including but not limited to a matrix that; includes a depth value for each pixel of the observed scene. In FIG. 4, the depth map 402 is schematically illustrated as a pixilated grid of the silhouette of the viewer 108. This illustration is for simplicity of understanding, not technical accuracy. It is to be understood that a depth map generally includes depth information for all pixels, not just pixels that image the viewer 108.

A virtual skeleton 404 may be derived from the depth map 402 to provide a machine readable representation of the viewer 108. In other words, the virtual skeleton 404 is derived from depth map 402 to model the viewer 108. The virtual skeleton 404 may be derived from the depth map 402 in any suitable manner. In some embodiments, one or more skeletal fitting algorithms may be applied to the depth map. The present disclosure is compatible with virtually any skeletal modeling techniques.

The virtual skeleton 404 may include a plurality of joints, and each joint may correspond to a portion of the viewer 108. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.). Furthermore, it; is to be understood that audio recognition and/or other detection mechanisms may be used instead of or in addition to skeletal tracking.

As shown in FIG. 4, a virtual avatar 406 may be rendered on display device 104 as a visual representation of virtual skeleton 404. Because virtual skeleton 404 models the viewer 108, and the rendering of the virtual avatar 406 is based on the virtual skeleton 404, the virtual avatar 406 serves as a viewable digital representation of the viewer 108. As such, movement of virtual avatar 406 on display device 104 reflects the movements of the viewer 108.

The virtual skeleton of a modeled viewer may be analyzed to determine if the natural user interface behavior of the viewer satisfies a condition of the promotion. For example, if the promotion indicates a viewer is to raise a hand during a particular scene of a video program, the processing pipeline may model the viewer, and the relative position of a hand joint of the virtual skeleton can be analyzed to determine if the corresponding hand of the user is raised.

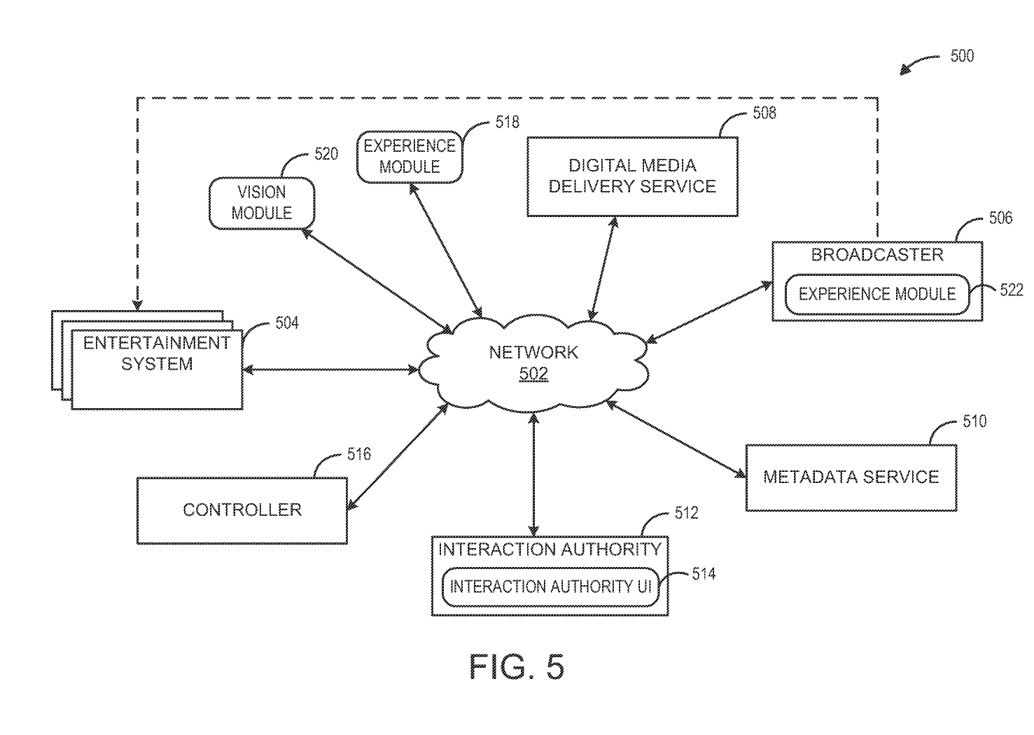

FIG. 5 shows an example promotion system 500 according to an embodiment of the present disclosure. The promotion system 500 may facilitate the execution of promotions associated with linear video content. In FIG. 5, the devices and modules of the promotion system 500 are depicted separate from one another, and each may communicate with other devices via a network 502. However, in some embodiments, two or more of the devices and/or modules may be integrated.

The promotion system 500 includes one or more entertainment systems 504 that are configured to receive linear video content from a broadcaster 506. The entertainment system 504 may also receive linear video content from a digital media delivery service 508. The entertainment system 504 is configured to display linear video content and deliver promotions to a viewer. Entertainment system 102 of FIG. 1 is a nonlimiting example of such an entertainment system.

The entertainment system 504 may receive information from one or more sources in order to execute the promotion. The promotion information may be sent to the entertainment system 504 from the digital media delivery service 508 along with the linear video content. In some embodiments, the promotion information may be sent from a metadata service 510. The metadata service 510 may provide metadata associated with the linear video content, such as title of the video content, length of the video content, etc., to the entertainment system 504. The metadata may also include promotion information, such as a time when the promotion is to start. In this way, promotions may be automatically started from information received from the metadata service 510. In some embodiments, the metadata service 510 may be included in the digital media delivery service 508, or may be included in a device belonging to a broadcaster 506.

One or more creators of a promotion may register the promotion with an interaction authority 512 via an interaction authority user interface 514. The details and conditions of the promotion may be stored on the interaction authority 512. The interaction authority 512 may send the promotion information to the entertainment system 504 in order to initiate the promotion. The promotion information can be sent directly from the interaction authority 512 to the entertainment system 504, or it can be sent via the digital media delivery service 508, the metadata service 510, or the broadcaster 506.

The promotion information sent to the entertainment system 504 may include a promotion start, time. For promotions that are included in non-live linear video content, the start time may be included as a metadata indicating the playback time that the promotion is to begin. However, for live linear video content, the exact start time of the promotion need not be set in advance. In this circumstance, an outside entity, such as a producer of the video content, a creator of the promotion, etc. may use a controller 516 to dynamically indicate the start of the promotion. The controller 516 may be configured to specify any aspects of the promotion that are not set in advance. This may also include selecting a viewer to participate in a promotion.

Once a promotion begins, an experience module 518 associated with the entertainment system 504 may launch. The experience module 518 may be configured to receive information regarding one or more conditions of the promotion, receive observation information from one or more sensors, and interpret the observation information. The experience module 518 may further be configured to execute an experience instruction upon receipt of the observation information. A vision module 520 may assist the experience module 518 in interpreting the received observation information. The vision module 520 may be configured to recognize objects displayed by the viewer, determine which actions the viewer is performing, etc. While shown separately in the depicted embodiment, the experience module 518 and the vision module 520 may be integrated as part, of the entertainment system 504.

In some embodiments, a device of the broadcaster 506 may also include an experience module 522. For example, the broadcaster's experience module 522 may be configured to communicate with the experience module 518 of the entertainment system. The broadcaster's experience module 522 may be configured to receive the interpretation of the natural user interface behavior of the viewer from the entertainment system 504 (e.g., as an avatar). As explained above with respect to FIG. 3, such information may optionally be used to incorporate a representation (e.g., avatar or direct video feed) of the viewer into the video program.

In some embodiments, the above described methods and processes may be tied to a computing system including one or more computers, in particular, the methods and processes described herein may be implemented as a computer application, computer service, computer API, computer library, and/or other computer program product.

FIG. 6 schematically shows a non-limiting entertainment system 600 that may perform one or more of the above described methods and processes. Entertainment system 102 of FIG. 1 is a nonlimiting example of such an entertainment; system.

Entertainment system 600 is shown in simplified form. It is to be understood that virtually any computer architecture may be used without departing from the scope of this disclosure. In different embodiments, entertainment system 600 may take the form of a desktop computer, laptop computer, tablet computer, home entertainment computer, network computing device, mobile computing device, mobile communication device, gaming device, etc.

Entertainment system 600 includes a logic subsystem 602 and a data-holding subsystem 604. Entertainment system 600 may optionally include a display subsystem 606, communication subsystem 608, sensor subsystem 610, and/or other components not shown in FIG. 6. Entertainment system 600 may also optionally include user input devices such as keyboards, mice, game controllers, cameras, microphones, and/or touch screens, for example.

Logic subsystem 602 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 604 may include one or more physical, non-transitory, devices configured to hold data and/or instructions executable by the logic subsystem to implement the herein described methods and processes. When such methods and processes are implemented, the state of data-holding subsystem 604 may be transformed (e.g., to hold different data).

Data-holding subsystem 604 may include removable media and/or built-in devices. Data-holding subsystem 604 may include optical memory devices (e.g., CD, MD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 604 may include devices with one or more of the following characteristics: volatile, nonvolatile, dynamic, static, read/write, read-only, random access, sequential access, location addressable, file addressable, and content addressable. In some embodiments, logic subsystem 602 and data-holding subsystem 604 may be integrated into one or more common devices, such as an application specific integrated circuit or a system on a chip.

FIG. 6 also shows an aspect of the data-holding subsystem in the form of removable computer-readable storage media 616, which may be used to store and/or transfer data and/or instructions executable to implement the herein described methods and processes. Removable computer-readable storage media 616 may take the form of CDs, DVDs, HD-DVDs, Blu-Ray Discs, EEPROMs, and/or floppy disks, among others.

It is to be appreciated that data-holding subsystem 604 includes one or more physical, non-transitory devices. In contrast, in some embodiments aspects of the instructions described herein may be propagated in a transitory fashion by a pure signal an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of entertainment system 600 that is implemented to perform one or more particular functions. In some cases, such a module, program, or engine may be instantiated via logic subsystem 602 executing instructions held by data-holding subsystem 604. It is to be understood that different modules, programs, and/or engines ma be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 606 may be used to present a visual representation of data held by data-holding subsystem 604. As the herein described methods and processes change the data held by the data-holding subsystem, and thus transform the state of the data-holding subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or data-holding subsystem 604 in a shared enclosure, or such display devices may be peripheral display devices.

When included, communication subsystem 608 may be configured to communicatively couple entertainment system 600 with one or more other computing devices. Communication subsystem 608 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow entertainment system 600 to send and/or receive messages to and/or from other devices via a network such as the Internet. Communication subsystem 608 may also include a module input to receive an experience module associated with the video program from an interaction authority or a metadata service.

Television module 614 may receive linear video content from a variety of sources, such as satellite, cable, over-the-airwaves broadcast, the Internet, etc. Television module 614 may be connected to one or more external tuners (not shown) that receive the linear video content and translate it into a format understandable by the entertainment system 600 (e.g., translate encrypted video into unencrypted MPEG 4). Television module 614 may also include an output configured to output the linear video content to the display subsystem 606.

Sensor subsystem 610 may include an input to receive from one or more sensors observation information indicating a natural user interface behavior of a viewer. In some embodiments, sensor subsystem 610 may include a depth camera.

Depth camera 612 may be a stereoscopic vision system including left and right cameras. Time-resolved images from both cameras may be registered to each other and combined to yield depth-resolved video.

In other embodiments, depth camera 612 may be a structured light depth camera configured to project a structured infrared illumination comprising numerous, discrete features (e.g., lines or dots). Depth camera 612 may be configured to image the structured illumination reflected from a scene onto which the structured illumination is projected. Based on the spacings between adjacent features in the various regions of the imaged scene, a depth map of the scene may be constructed.

In other embodiments, depth camera 612 may be a time-of-light camera configured to project a pulsed infrared illumination onto the scene. The depth camera may include two cameras configured to detect the pulsed illumination reflected from the scene. Both cameras may include an electronic shutter synchronized to the pulsed illumination, but the integration times for the cameras may differ, such that a pixel-resolved time-of-flight of the pulsed illumination, from the source to the scene and they to the cameras, is discernable from the relative amounts of light received in corresponding pixels of the two cameras.

Sensor subsystem 610 may additionally or alternatively include a visible light camera, such as a web cam or other suitable still image or moving image video camera.

In some embodiments, sensor subsystem 610 may include one or more peripheral devices. As a nonlimiting example, a mobile telephone may serve as a component of the sensor subsystem. A mobile telephone may include a camera or other sensor capable of scanning a bar code, for example, and the mobile telephone may be configured to send information acquired from such scans to logic subsystem 602 for processing.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An entertainment system, comprising:
a sensor input to receive from one or more sensors observation information indicating a natural user interface behavior of a viewer;
a program input to receive from a broadcaster a video program;
an output configured to output to a display the video program; and
a module input to receive from an interaction authority an experience module associated with the video program, the experience module configured to execute an experience instruction if the natural user interface behavior of the viewer satisfies a condition defined by the experience module.

2. The system of claim 1, wherein the experience instruction executed by the experience module includes sending an interpretation of the natural user interface behavior of the viewer to the broadcaster.

3. The system of claim 2, wherein the interpretation is usable by the broadcaster to display an avatar of the viewer within the video program.

4. The system of claim 1, wherein the experience instruction sends an interpretation of the natural user interface behavior to the interaction authority.

5. The system of claim 4, wherein the interpretation is usable by the interaction authority to determine if the natural user interface behavior of the viewer satisfies a predetermined condition for qualifying for an award.

6. The system of claim 1, wherein the experience instruction requests an award be given to the viewer from the interaction authority.

7. The system of claim 1, wherein the experience instruction requests an award be given to the viewer from the broadcaster.

8. The system of claim 1, wherein the experience instruction unlocks a previously downloaded and blocked award.

9. The system of claim 1, wherein the sensor includes a depth camera.

10. The system of claim 1, wherein the sensor includes a microphone.

11. The system of claim 1, wherein the experience module is received from the interaction authority via a metadata service.

12. A method for enabling promotions, comprising:
receiving a promotion detailing a natural user interface behavior performable by a viewer;
receiving an interpretation of a natural user interface behavior of a viewer performed while viewing a video program; and
requesting an award be given to the viewer if the natural user interface behavior of the viewer satisfies a condition of the promotion.

13. The method of claim 12, wherein the natural user interface behavior of the viewer includes an action detectable by a camera and/or microphone.

14. The method of claim 12, wherein the interpretation includes an avatar of the viewer.

15. The method of claim 12, wherein requesting an award be given to the viewer includes notifying the broadcaster that the natural user interface behavior of the viewer satisfies the condition of the promotion.

16. A method of displaying an avatar of a viewer in a live video broadcast, comprising:
obtaining a live video feed;
receiving an interpretation derived from a natural user interface behavior of the viewer observed by a sensor; and
outputting a representation derived from the interpretation within the live video feed.

17. The method of claim 16, wherein the sensor includes a depth camera.

18. The method of claim 16, wherein the representation is an avatar of the viewer.

19. The method of claim 16, wherein the natural user interface behavior of the viewer includes an action detectable by a camera and/or microphone.

20. The method of claim 19, further comprising sending a notification to a server to grant an award to the viewer if the natural user interface behavior of the viewer meets a condition of a promotion.
